(19) United States
(12) Patent Application Publication
(10) Pub. No.: US 2007/0226985 A1
(43) Pub. Date: Oct. 4, 2007

(54) Apparatus and method for an adjustable tool holder

(75) Inventors: Michael A. Paton, Oconomowoc, WI (US); Trent A. Powell, Sussex, WI (US); Charles A. Urbanek, Franklin, WI (US)

Correspondence Address: FOLEY & LARDNER LLP, 777 EAST WISCONSIN AVENUE, MILWAUKEE, WI, 53202-5306, US

(73) Assignee: Citation Corporation

(21) Appl. No.: 11/396,754

(22) Filed: Apr. 3, 2006

(51) Int. Cl. B23P 11/00

(52) U.S. Cl. 29/525.01; 29/525.11

(57) ABSTRACT

A method of making an adjustable tool holder includes providing a tool holder body portion having a spindle-end portion and a shoulder portion and a neck portion and a bore. A collar having a plurality of threaded apertures is provided to engage the neck portion in a heat shrink relationship. The collar is heated to a predetermined temperature and placed over the neck portion at a predetermined location. The collar is allowed to cool on the neck portion, and threaded members having a length sufficient to engage the shoulder are installed in the threaded apertures of the collar.

### FIELD

The present invention relates generally to an apparatus and method for making an adjustable tool holder. The present invention relates more particularly to an apparatus and method for converting a non-adjustable tool holder to an adjustable tool holder.

### BACKGROUND

Power operated machine tools typically include a rotating spindle arranged to receive a tool holder, where the tool holder grips or holds the shank of a cutting tool for machining a work product. The life and performance of the cutting tool and the quality of the resulting work product are enhanced when the axial alignment of the tool within the tool holder and the spindle can be adjusted (e.g. “tuned,” “trued” “centered” etc.) to minimize axial misalignment (e.g. “run-out” etc.) of the tool to a desired degree (based on the type of machine, tool, and work product, etc.), such as, for example, about one ten thousandths of an inch for certain applications.

Conventional tool holders are commercially available as either “non-adjustable” or “adjustable.” Non-adjustable type tool holders (e.g. those that grip the tool by set-screw, heat shrink, collet, chuck, etc.) are relatively inexpensive and popular due to their generally simplistic design and low cost. However, such non-adjustable tool holders do not permit a user to adjust the tool position to minimize axial misalignment at the tool, which may occur due to inaccuracies in any one or more of the machine spindle, the tool holder or the tool (e.g. tolerance stack-up, etc.). On the other hand, conventional adjustable tool holders, such as tool holders that grip the shank of the tool using a hydraulic sleeve, while permitting some adjustment of the tool's position, are relatively expensive and often cost-prohibitive for many types of machining applications.

Thus, the conventional tool holders commercially available for machining operations typically involve a trade-off that requires the user to select between a low cost, reduced accuracy product and a high-cost, improved accuracy product.

Accordingly, it would be desirable to provide a relatively low-cost tool holder with an adjustment device for adjusting the position of a tool held by the tool holder. It would also be desirable to provide an apparatus and method for adding an adjustment device or feature to a conventional non-adjustable tool holder. It would also be desirable to provide an apparatus and method for converting a conventional non-adjustable tool holder to an adjustable tool holder. It would also be desirable to provide an adjustable tool holder apparatus and method that is adaptable to tool holders in a wide variety of sizes. It would also be desirable to provide an apparatus and method for providing an adjustable tool holder that is relatively inexpensive, and can be reliably implemented in a quick and easy manner. It would also be desirable to provide a method and apparatus for adding an adjustment device to a non-adjustable tool holder that can be implemented while the tool and tool holder are mounted in a machine spindle, or before the tool and tool holder are mounted in the machine spindle.

Accordingly, it would be desirable to provide an apparatus and method for an adjustable tool holder having any one or more of these or other advantageous features.

### SUMMARY

One embodiment of the invention relates to a method of converting a non-adjustable tool holder to an adjustable tool holder and includes providing a non-adjustable tool holder having a shoulder and a neck, providing a collar engageable with the neck, attaching the collar to the neck, and providing force generators engageable with the collar and the shoulder; the force generators operable to deflect the collar relative to the shoulder and adjust an axis of the neck.

Another embodiment of the invention relates to a method of converting a non-adjustable tool holder to an adjustable tool holder. The method includes providing a non-adjustable tool holder having a shoulder and a neck and providing a collar engageable with the neck. The collar is heated a temperature sufficient to permit the collar to be placed over the neck and then the collar is placed over the neck. The collar is cooled to lock the collar onto the neck; and force generators engageable with the collar and the shoulder are provided, where the force generators are operable to deflect the collar relative to the shoulder.

Another embodiment of the invention relates to a method of adjusting a tool in a tool holder. The method includes providing a tool holder body having a spindle-end portion and a shoulder and a neck and bore, the bore extending axially into the neck and securing a tool in the bore. An axial alignment condition of the tool in the bore is measured and a collar having a plurality of threaded apertures is provided. The collar is heated to a predetermined temperature and placed over the neck, and then the collar is cooled to lock the collar on the neck. Threaded members are installed through the threaded apertures, where the threaded members engage the shoulder to develop a force between the collar and the shoulder to adjust a position of the tool.

### BRIEF DESCRIPTION OF THE DRAWINGS

FIG. 1 is a schematic representation of an exploded perspective view of an apparatus for an adjustable tool holder according to an embodiment.

FIG. 2 is a schematic representation of an assembled perspective view of an apparatus for an adjustable tool holder according to the embodiment of FIG. 1.

FIG. 3 is a schematic representation of an exploded front elevation view of an assembled apparatus for an adjustable tool holder according to the embodiment of FIG. 1.

FIG. 4 is a schematic representation of an exploded perspective view of an apparatus for an adjustable tool holder according to another embodiment.

FIG. 5 is a diagrammatic representation of a method of providing an adjustable tool holder according to an embodiment.

### DETAILED DESCRIPTION

Referring to the FIGURES, an embodiment of an apparatus and method for an adjustable tool holder is shown for use with-a machine of a type having a rotating spindle to receive the tool holder. The tool holder according to the illustrated embodiment is shown and described by way of example as a “heat shrink” type non-adjustable tool holder that grips a shank of a tool by heat-shrinking the neck of the tool holder over the shank of the tool. However, the apparatus and method may be adapted for use with any type of tool holder, such as set-screw type holders, collet or chuck type holders, etc. for use with any of a wide variety of tools, machines, and spindle configurations. Accordingly, all such variations are contemplated and intended to be within the scope of the disclosure.

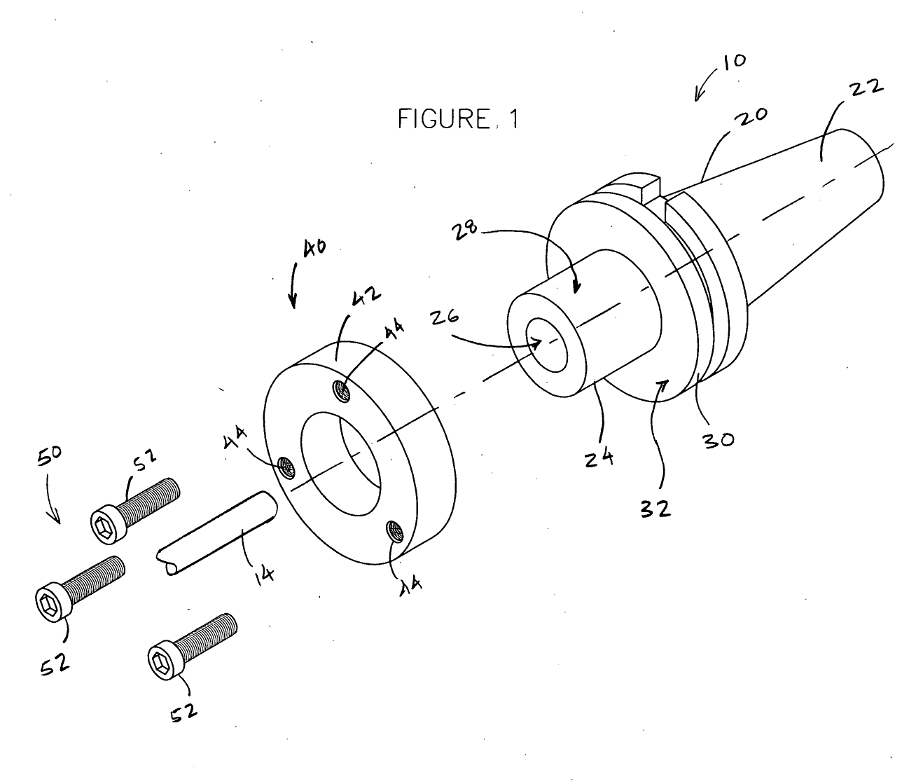

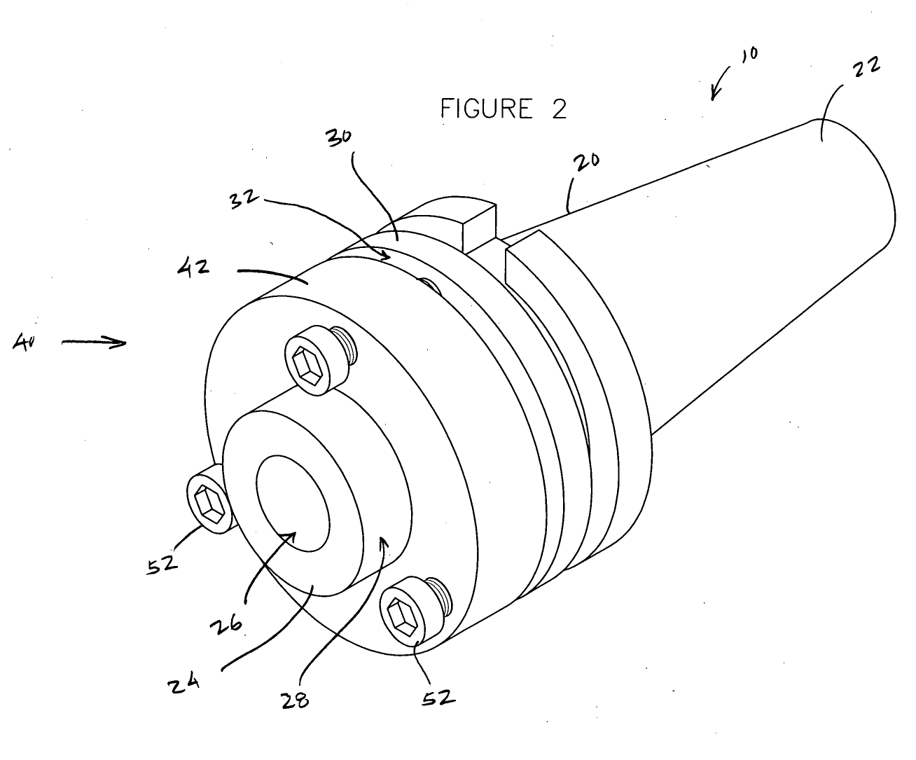

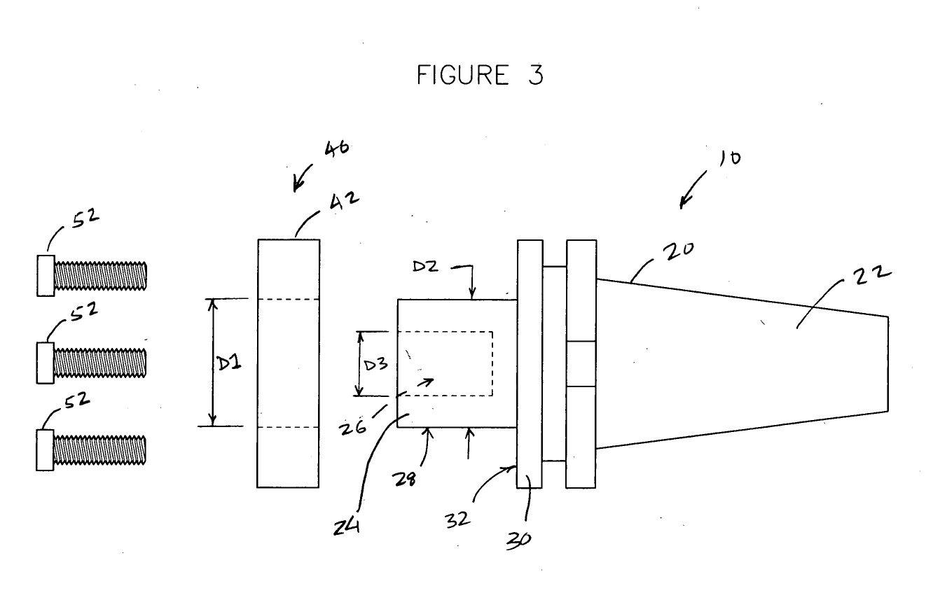

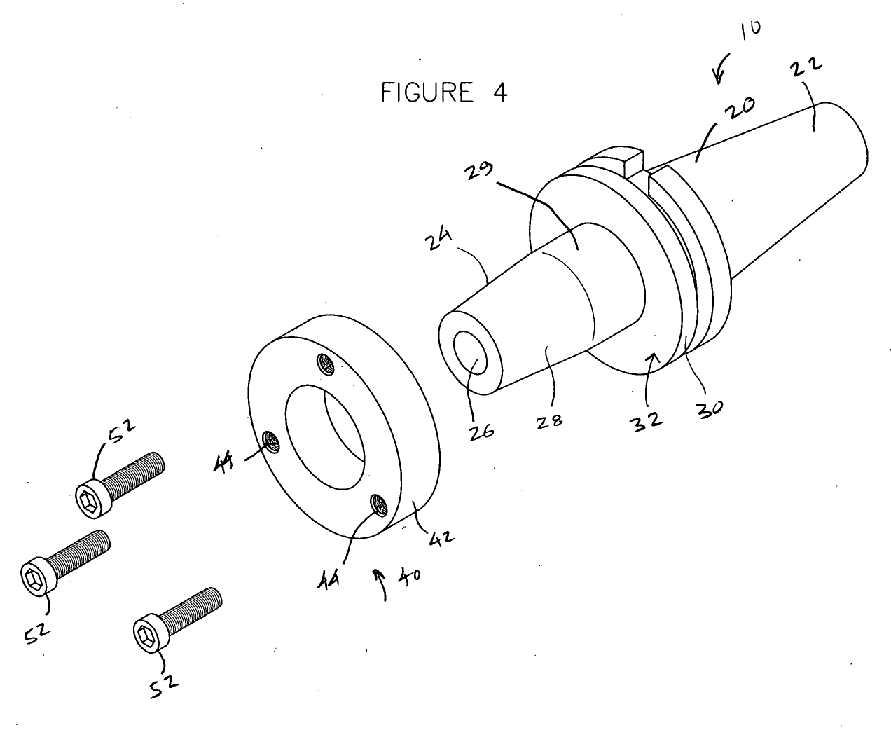

According to one exemplary embodiment shown in FIGS. 1-3, a tool holder 10 is shown having a body portion 20. The body portion 20 is shown to include several components, including a generally cone-shaped spindle-end portion 22 having a size and shape configured to be received in a spindle of a machine (not shown—e.g. drill, mill, lathe, etc.). The body portion 20 also includes an opposite end arranged in the form of a neck portion 24 having on opening 26 (e.g. bore, aperture, etc.) therein sized to receive the shank of a tool. According to other embodiments, the neck portion may be arranged to receive a tool using other suitable holding devices such as a chuck, collet, taper holder, etc. An outer surface 28 of neck portion 24 may be generally cylindrical (as shown in FIGS. 1 and 3) to receive an adjustment device to be further described. According to another embodiment, the outer surface 28 may be tapered (e.g. cone shaped or have a generally frustoconical shape, etc.) as shown for example in FIG. 4. The size of the neck portion 24 and the opening 26 are configured to receive the shank 14 of a tool of a corresponding size. The size of the neck and the bore are shown for example in FIGS. 1-4 as a single size, but may be provided in a wide variety of sizes for use with a wide variety of tools. The body portion 20 also includes a shoulder portion 30 located between the spindle-end portion 22 and the neck portion 24. The shoulder portion 30 includes a generally planar bearing surface 32 extending generally perpendicular to an axis of the body portion 20 and facing toward the neck portion 24. According to a preferred embodiment, the body portion 20 of the tool holder 10 is formed as a single unitary piece, such as are commercially available in a variety of sizes (as a non-adjustable tool holder) from (among others) Kennametal Inc. of Latrobe, Pennsylvania. According to an alternative embodiment, the body portion may be formed from separate components that are assembled together for use as a tool holder.

Referring further to FIGS. 1-4, the tool holder 10 is shown to include an adjustment device 40 according to an embodiment. The adjustment feature 40 is shown schematically to include a collar 42 (e.g. ring, tube, cylinder, sleeve, etc.) having a size selected to engage and be secured upon the outer surface 28 of the neck portion 24. The collar 42 is shown as a circular-shaped member, but may be provided with any shape that is rotatably balanceable for use in rotating machinery (e.g. square, triangular, with projecting lobes, etc.). The collar may also be provided as a unitary piece, or may be provided in one or more pieces that are assembled together to form the collar (e.g. split-ring, etc.). The collar is provided with an opening D1 sized to fit over the neck portion, and to be secured on the outer surface 28 of the neck portion 24 at a desired location proximate the shoulder, using any suitable means of attachment including, but not limited to, temperature differential, welding, clamping, fasteners, threaded engagement, interference, etc. For example, attachment by temperature differential may include heating the collar and/or cooling (e.g. “freezing”) the neck portion to thermally interlock (e.g. “heat shrink”) the collar to the neck portion. Attachment by welding may be accomplished by fusing the collar and neck together by welding, brazing, etc. Attachment by clamping may be accomplished by providing the collar as two halves that assemble on opposite sides of the neck portion and are drawn together (using fasteners or the like) to clamp the neck portion between the two halves of the collar. Attachment by use of fasteners may be accomplished through the use of one or more set screws or the like extending radially through the collar walls to engage the neck portion (such as in the manner of a “Christmas tree stand” etc.). Attachment by threaded engagement may include providing threads on the outer surface of the neck portion and on the surface of the opening in the collar for rotatably coupling the collar to the neck portion. Attachment by interference fit may include providing a close tolerance fit so that the collar becomes axially misaligned with the neck and sufficiently “wedged” or “cocked” on the neck portion when forces are applied on the collar in an uneven manner. Accordingly, any suitable method of attachment may be employed for securing the collar to the neck portion at a desired location proximate the shoulder. According to an alternative embodiment, the collar may be integrally formed on (or with) the neck portion during formation of the tool holder.

According to a presently preferred embodiment, the collar 42 is heat shrunk onto the neck portion 24 at a location that is closely adjacent to the bearing surface 32 of the shoulder portion 30. According to one embodiment, a gap of approximately one-eighth inch, for example, may be provided between the shoulder 30 and the collar 42, however, a gap having any suitable dimension may be used. The collar 42 is also shown to include a plurality of apertures 44 (shown for example as three (3) threaded apertures 44 that are generally equidistantly spaced to maintain the rotational balance of the tool holder when installed thereon. However, according to an alternative embodiment, the number of apertures may be more or less than three (e.g. two, four, etc.), as desired, and provided in any suitable spacing or arrangement, and provided with or without threads). According to a preferred embodiment, the collar is formed as a single unitary piece having an outside diameter of approximately 2.480 inches (or within the range of 2.460-2.50 inches) and a thickness of approximately 0.625 inches (or within a range of 0.620-0.630 inches) from a metallic material such as steel, but may be formed with any suitable size and from any suitable material that can be heat shrunk onto the neck portion.

According to a presently preferred embodiment, an inside diameter D1 of the collar 42, and an outside diameter D2 of the neck portion 24 are sized to provide an FN3 class fit (or other suitable fit), for heat shrink application of the collar 42 onto the neck portion 24. In the event that the neck portion of the tool holder body is tapered (such as shown in FIG. 4), the neck portion may be machined (e.g. “turned-down”, “qualified” etc.) to provide a generally cylindrical section 29 (e.g. step, ring, etc.) to receive the collar 42 and upon which the collar can “seat” when the collar is attached to the neck. Alternatively, the inside opening of the collar may be provided with a taper suitable for use on the tapered neck portion. According to other embodiments, the diameters D1 and D2 may be provided in any suitable relationship to facilitate attachment of the collar to the neck portion using other desired means of attachment (such as welding, clamping, fasteners, threaded engagement, interference, etc.).

Referring further to FIGS. 1-4, force generators 50 are provided that are engageable with the collar 42 and the shoulder 30 of the tool holder. According to the illustrated embodiment, the force generators 50 are shown for example as threaded members, and more particularly as jacking screws 52. The jacking screws 52 have a length sufficient to engage (e.g. contact, bear upon, etc.) or otherwise coact with the bearing surface 32 of shoulder 30, so that one or more of the jacking screws 52 may be selectively rotated (e.g. tightened, etc.) through the collar and against the bearing surface 32 to generate a force tending to “expand” (e.g. push-apart, etc.) the shoulder and collar away from each other. The force produces a bending moment in the neck that tends to “deflect” (e.g. bend, flex, arch, tilt, etc.) the neck so that a tool held in the opening is repositioned relative to an axis of the tool holder. A user may selectively “tighten” any one or more of the jacking screws to produce a force sufficient to “bend” at least a portion of the neck as necessary to adjust the axial alignment of the tool. Note that the threaded apertures in the collar 42 and the jacking screws 52 are shown to be oriented along an axis parallel to center axis of the tool holder. However, according to alternative embodiments, the apertures and jacking screws may be configured at any desirable angle relative to the center axis of the tool holder. According to a preferred embodiment, the threaded apertures 44 of the collar 42 are ¼ inch—28 UNF and are provided with a counterbore sized to receive the head of the jacking screw 52. Likewise, the jacking screws have a corresponding diameter and thread pattern to engage the threaded apertures and have a length sufficient to engage the bearing surface 32 of shoulder 30.

According to alternative embodiments, the force generators may be other devices such as clamps, wedges, etc. that are arranged to generate a force (tension or compression) between the collar and the shoulder to induce bending in the neck of the tool holder body. In addition, the jacking screws may be arranged to pass through apertures in the collar and thread into apertures on the shoulder so that the shoulder and the collar are urged toward one another (e.g. pulled-together, compressed, drawn-together, etc.).

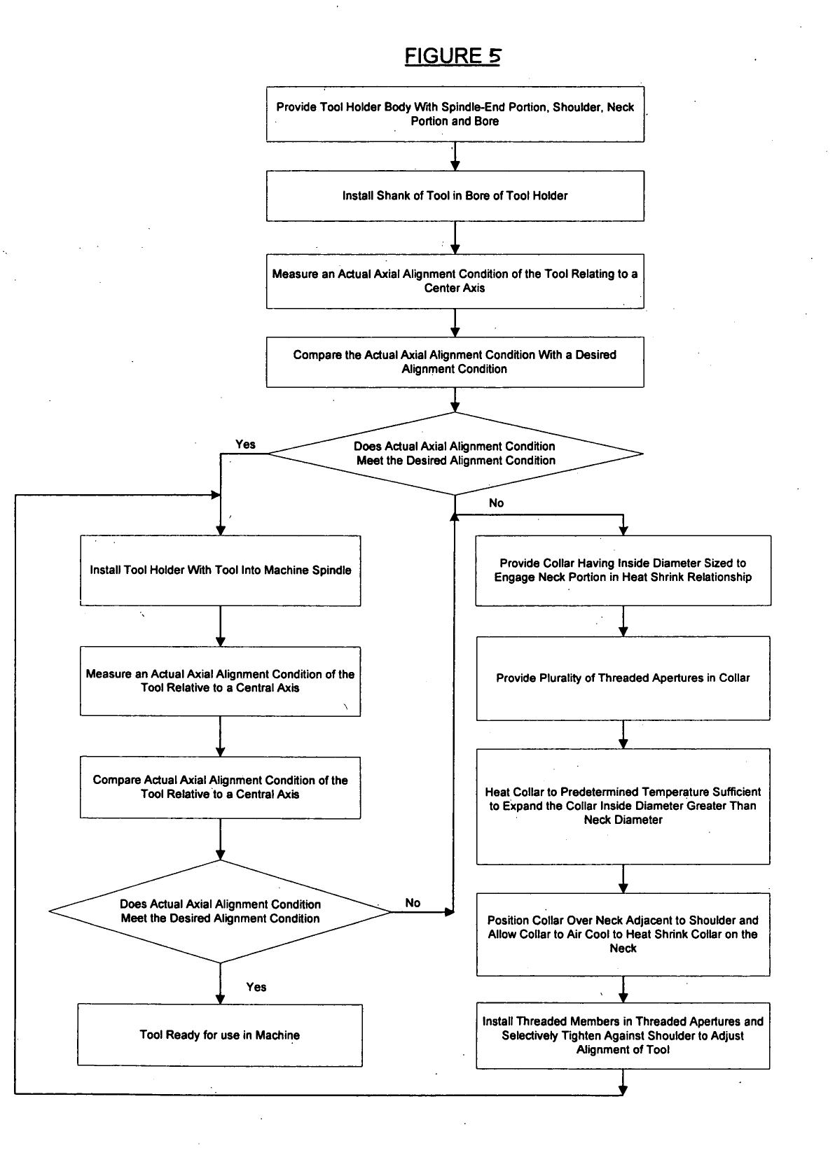

Referring to FIG. 5, a method of providing an adjustable tool holder is provided according to an embodiment. The method involves selecting a low-cost, non-adjustable type tool holder suitable for use with a tool for an intended application. The tool is secured in the opening 26 or bore of the neck portion 24 using any one of a variety of tool-holding structure or technologies such a setscrew, a collet, a chuck, a heat shrink operation, etc. The tool 14 and tool holder may then be checked for an “actual” axial alignment condition, such as by placing the tool and tool holder assembly into a commercially available laser alignment monitor, or a dial-indicator fixture, etc. and rotating the assembly about a central axis to measure the actual axial alignment condition of the tool relative to the central axis. The actual axial alignment condition is then compared to a predetermined axial alignment criteria (or required tolerance condition, etc.) desired for an intended application of the tool. According to one embodiment, the predetermined axial alignment criteria is typically on the order of one (or several) ten-thousandths of an inch. In the event that the tool and tool holder assembly does not meet the predetermined axial alignment criteria, the tool holder may be adjusted (or the “non-adjustable” tool holder may be converted to an “adjustable” tool holder) by installation and activation of the adjustment device 40.

Installation of the adjustment device 40 on the neck portion of the tool holder may be accomplished according to any of a variety attachment methods as previously described. According to the illustrated embodiment of FIG. 5 by way of example, installation of the adjustment device 40 on the neck portion involves heating the collar (e.g. in an oven, by induction heating, etc.) to a predetermined temperature sufficient to thermally expand the inside diameter D1 of collar 42 a sufficient amount to permit the collar to be placed over the outside diameter D2 of the neck portion 24 (and may also include “freezing” the neck portion to enhance the thermally-induced fit of the collar and the neck). According to a preferred embodiment, the predetermined temperature is greater than 1000 degrees F., and more particular the predetermined temperature is approximately 1225 degrees F. The collar 42 is placed over the neck portion 24 and positioned at a location adjacent (e.g. relatively near to) the bearing surface 32 of the shoulder 30. According to a preferred embodiment, the collar 42 is located such that a gap of approximately 0.125 inches (or within the range of 0.115 and 0.135 inches) is maintained between the collar 42 and the shoulder 30, however, any suitable gap dimension may be used. A user installing a collar onto a neck portion may find the use of a shimming tool having the desired gap dimension helpful for quickly and conveniently setting the location of the collar onto the neck portion. Once the collar 42 is positioned over the neck portion 24 in the desired location, the collar 42 is allowed to cool so that the collar 42 is “locked” onto the neck portion 24 by a heat shrink relationship. According to other embodiments, the collar may be secured on the neck using other attachment methods as previously described.

The adjustment device 40 is then activated by installation of jacking screws 52 that are threaded through apertures 44 in the collar 42 until the screws 52 engage (e.g. contact, touch, etc.) the bearing surface 32. A user may selectively rotate (e.g. “tighten”) any one or more of the screws 52 to generate a force sufficient to bend the neck portion 24 an amount necessary to adjust the position of the tool and “bring the tool into tolerance” by moving the tool such that the actual axial alignment condition meets the required alignment criteria.

The “adjusted” tool and holder assembly may be installed onto a machine by fitting the spindle-end portion of the tool holder onto the machine spindle. Due to the possibility that the machine spindle may be slightly out of alignment, the user may also check the actual axial alignment condition of the tool and tool holder assembly on the machine (e.g. with a dial indicator fixture or other suitable device) and adjust the tool position by selectively rotating (e.g. tightening or loosening) the jacking screws 52. Thus, the adjustment device may be installed and “activated” before and/or after the tool and tool holder assembly are mounted on the machine.

According to any preferred embodiment, a method and apparatus for providing a low-cost, easy-to-use, adjustable tool holder is provided. The tool holder includes a body portion having a spindle-end portion, a shoulder, and a neck portion with an axial opening to hold a tool shank. The body portion may be custom-made as a unitary piece, or assembled from a variety of sub-component parts (that may be at least partially interchangeable), or the body portion may be provided as a commercially-available tool holder of a non-adjustable type. The shank of a tool is secured in the opening of the neck portion of the tool holder, and an axial alignment condition of the tool is checked using any desirable method (such as a dial indicator fixture or arrangement, laser alignment monitor, etc.). In the event that the alignment condition of the tool does not meet predetermined requirements or tolerance criteria established for the intended application, then the tool holder is provided with an adjustment device that permits selectively adjusting the position of the tool within the tool holder (and also with the tool and tool holder installed into a machine spindle). The adjustment device includes a collar that is sized to be installed over the neck portion (near the shoulder) and locked in position using any one of a thermal differential (e.g. heat-shrink interference fit), welding, clamping, fasteners, threaded engagement, etc. The collar includes several threaded openings to receive jacking screws that are arranged in a manner that preserves the rotational balance of the tool and tool holder assembly. The jacking screws may be threaded through the collar and selectively tightened against the shoulder as necessary to deflect (e.g. bend, flex, tilt, etc.) the neck portion in a desired direction so that an the alignment condition of the tool is adjusted to meet the predetermined alignment criteria or tolerance requirements for the intended application.

The construction and arrangement of the elements and steps of the apparatus and method for an adjustable tool holder as shown in the various embodiments is illustrative only. Although only a few embodiments of the present invention have been described in detail in this disclosure, those skilled in the art who review this disclosure will readily appreciate that many modifications are possible (e.g., variations in sizes, dimensions, structures, shapes, contours and proportions of the various elements, methods of formation, methods of attaching the collar to the neck portion, values of parameters, mounting arrangements for the force generators between the collar and the shoulder, use of various technologies to hold the tool within the holder, etc.) without materially departing from the novel teachings and advantages of the subject matter recited herein. Also, elements shown as integrally formed may be constructed of multiple parts, components or elements, the position of elements may be reversed or otherwise varied, (e.g., the jacking screws may be arranged for use in a tension or compression manner to generate a force sufficient to bend the neck portion), and the nature or number of discrete elements or positions may be altered or varied (e.g., the collar may be provided at any suitable location on the neck portion, also if the neck portion is tapered, the inside diameter of the collar may also be tapered, further the collar, neck portion and opening may be provided in any of a wide variety sizes to accommodate a wide variety of tools). It should be noted that the elements of the adjustable tool holder (e.g. body portion, adjustment device and force generators) may be constructed from any of a wide variety of materials and in any of a wide variety of colors, textures and combinations. It should also be noted that the description of the method of converting a non-adjustable tool holder to an adjustable tool holder are by way of one example, and the method steps may be supplemented, omitted, conducted in any sequence, or otherwise varied or modified. Other substitutions, modifications, changes and omissions may be made in the design, operating conditions and arrangement of the various embodiments without departing from the scope of the present invention.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the inventions as expressed in the claims provided in any future patent applications that claim priority to this Application.

What is claimed is:

1. A method of making an adjustable tool holder, comprising:
providing a tool holder body portion having a spindle-end portion and a shoulder portion and a neck portion and a bore;
integrally forming a collar on the neck portion;
providing a plurality of threaded apertures through the collar;
installing threaded members in the threaded apertures of the collar, the threaded members having a length sufficient to engage the shoulder.

2. The method of claim 1 wherein the plurality of threaded apertures is three threaded apertures and the threaded members are three threaded members.

3. The method of claim 1 wherein the predetermined location is proximate the shoulder portion.

4. The method of claim 1 wherein the neck is formed with a tapered profile.

5. The method of claim 1 further comprising selectively tightening at least one of the threaded members against the shoulder to obtain a predetermined axial alignment condition for a tool.

6. The method of claim 1 wherein the bore is configured to grip a tool using one of a heat shrink fit, a setscrew securement, a collet and a chuck.

7. A method of converting a non-adjustable tool holder to an adjustable tool holder, comprising:
providing a non-adjustable tool holder having a shoulder and a neck;
providing a collar engageable with the neck;
heating the collar to a temperature sufficient to permit the collar to be placed over the neck and placing the collar over the neck;
cooling the collar to lock the collar onto the neck; and
providing force generators engageable with the collar and the shoulder; the force generators operable to deflect the collar relative to the shoulder.

8. The method of claim 7 wherein the neck is provided as a tapered neck and further comprising the step of forming a cylindrical surface on the tapered neck.

9. The method of claim 7 wherein the collar comprises a plurality of threaded apertures.

10. The method of claim 9 wherein the force generators comprise jacking screws operably engaging the threaded apertures.

11. The method of claim 10 wherein at least one of the jacking screws is engageable with the shoulder to create a force sufficient to adjust an axial position of the neck.

12. The method of claim 7 wherein the step of cooling the collar comprises air cooling the collar.

13. A method of adjusting a tool in a tool holder, comprising:
providing a tool holder body having a spindle-end portion and a shoulder and a neck and bore, the bore extending axially into the neck;
securing a tool in the bore;
measuring an axial alignment condition of the tool in the bore;
providing a collar having a plurality of threaded apertures;
heating the collar to a predetermined temperature;
placing the collar over the neck;
cooling the collar to lock the collar on the neck;
installing threaded members through the threaded apertures, the threaded members configured to engage the shoulder to develop a force between the collar and the shoulder, wherein the force is sufficient to adjust a position of the tool.

14. The method of claim 13 further comprising the step of selectively rotating at least one of the threaded members to adjust a position of the tool.

15. The method of claim 13 further comprising the step of installing the spindle-end portion into a machine.

16. The method of claim 13 wherein the tool is secured in the bore through one of a setscrew, a collet, a chuck and a heat shrink operation.

17. The method of claim 13 wherein the neck comprises a tapered surface and further comprising the step of providing a cylindrical surface on the neck configured to receive the collar.

18. The method of claim 13 wherein the threaded elements are jacking screws.

19. The method of claim 13 wherein the collar is heated to a temperature of at least 1000 degrees F.

20. A method of converting a non-adjustable tool holder to an adjustable tool holder, comprising:
providing a non-adjustable tool holder having a shoulder and a neck;
providing a collar engageable with the neck;
attaching the collar to the neck,
providing force generators engageable with the collar and the shoulder;
the force generators operable to deflect the collar relative to the shoulder and adjust an axis of the neck.

21. The method of claim 20 wherein the step of attaching the collar to the neck comprises at least one of heating the collar and cooling the neck.

22. The method of claim 20 wherein the collar comprises two or more segments and the step of attaching the collar to the neck comprises clamping the-neck between the segments.

23. The method of claim 20 wherein the collar has threads formed therein and the neck has threads formed thereon and the step of attaching the collar to the neck comprises rotatably engaging the threads on the collar with the threads on the neck.

24. The method of claim 20 wherein the step of attaching the collar to the neck comprises misaligning an axis of the collar with the axis of the neck to create an interference.

25. The method of claim 20 wherein the step of attaching the collar to the neck comprises forming a welded connection between the collar and the neck.
